(19) United States
(12) Patent Application Publication
(10) Pub. No.: US 2024/0107468 A1
(43) Pub. Date: Mar. 28, 2024

(54) SUPPORT FOR CALIBRATING ROUND TRIP TIME ERRORS

(71) Applicant: QUALCOMM Incorporated, San Diego, CA (US)

(72) Inventors: Didier Johannes Richard VAN NEE, Tull en't Waal (NL); Xiaoxin ZHANG, Sunnyvale, CA (US); Alireza RAISSINIA, Monte Sereno, CA (US)

(21) Appl. No.: 17/951,850

(22) Filed: Sep. 23, 2022

(51) Int. Cl. H04W 56/00; H04L 43/106

(52) U.S. Cl. CPC H04W 56/001; H04L 43/106; H04W 64/00

(57) ABSTRACT

Certain aspects of the present disclosure provide a method for wireless communications at a first wireless node generally including generating a first frame associated with a timestamp, outputting the first frame, for transmission to a second wireless node, as part of a ranging procedure, and outputting, for transmission, signaling comprising information regarding a transmit impulse response of the first frame.

### BACKGROUND

### Field of the Disclosure

Aspects of the present disclosure relate to wireless communications, and more particularly, to techniques for calibrating errors in round trip time (RTT) measurements.

### Description of Related Art

Wireless communications networks are widely deployed to provide various communications services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communications systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (such as tens of meters to a few hundred meters).

802.11 has standardized a procedure to measure RTT between two devices (e.g., stations) to enable ranging and positioning. Aspects of the present disclosure provide mechanisms that may help enhance RTT measurements and increase the accuracy of such ranging and positioning procedures.

### SUMMARY

One aspect provides a method for wireless communications at a first wireless device. The method includes generating a first frame associated with a timestamp; outputting the first frame, for transmission to a second wireless node, as part of a ranging procedure; and outputting, for transmission, signaling comprising information regarding a transmit impulse response of the first frame.

Another aspect provides a method for wireless communications (and ranging procedures) at a second wireless node. The method includes obtaining a first frame used to estimate a timestamp as part of a ranging procedure; obtaining information regarding a transmit impulse response of the first frame; adjusting a receive timestamp for the first frame based on the information regarding the transmit impulse response of the first frame; and outputting a frame with a value determined based on the adjusted receive timestamp as part of the ranging procedure.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts an example round trip time (RTT) procedure.

FIG. 4 depicts an example of RTT with different transmit filtering.

FIG. 5 depicts another example of RTT with different transmit filtering.

FIG. 6 depicts example RTT error caused by filtering differences at a transmitter and receiver.

FIG. 7 depicts an example of RTT calibration.

FIG. 8 is an example call flow diagram for calibrating RTT errors, in accordance with aspects of the present disclosure.

FIG. 9 depicts a method for wireless communications.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for calibrating errors in round trip time (RTT).

RTT (round trip time) measurements have been widely used in various wireless systems, such as Wi-Fi, 5G NR, and ultra wideband (UWB) for ranging procedures. The ranging procedure typically involves two stations: an initiator (that initiated the ranging procedure) and a responder. A location session may be established for the ranging procedure, which may involve one or more bursts of packets, based on which one or more RTT measurements are obtained, which can be used to determine a distance (d=0.5·RTT·c).

Unfortunately, errors in RTT measurements can degrade positional accuracy of the ranging procedure. Accuracy may be especially pronounced when ranging procedures involve devices from different vendors. Despite each vendor calibrating their own devices, vendor-to-vendor tests still show significant RTT errors, which could lead to decimeter or even meter level errors in ranging accuracy. One cause of some of these errors could be the use of different transmit (Tx) filtering, which may result in errors in receive timestamps measured at the initiator and responder.

Aspects of the present disclosure may help reduce RTT errors by reporting TX filter response in ranging frames to facilitate the device who receives the ranging frame to estimate the RTT errors. The estimated RTT errors may be used to adjust receive time stamps, which may lead to more accurate RTT measurements and increased positional accuracy in the ranging procedures.

The techniques described herein may be applied to ranging procedures performed in a variety of different types of wireless networks, such as Wi-Fi, 5G NR, and UWB. Improved accuracy using the techniques proposed herein may help achieve certain design goals, such as centimeter-level ranging accuracy.

Various aspects of the disclosure are described more fully hereinafter with reference to the accompanying drawings. This disclosure may, however, be implemented in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be implemented by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communications systems, including communications systems that are based on an orthogonal multiplexing scheme. Examples of such communications systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (such as implemented within or performed by) a variety of wired or wireless apparatuses (such as nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a tablet, a portable communications device, a portable computing device (such as a personal data assistant), an entertainment device (such as a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communications link.

### Example Wireless Communications System

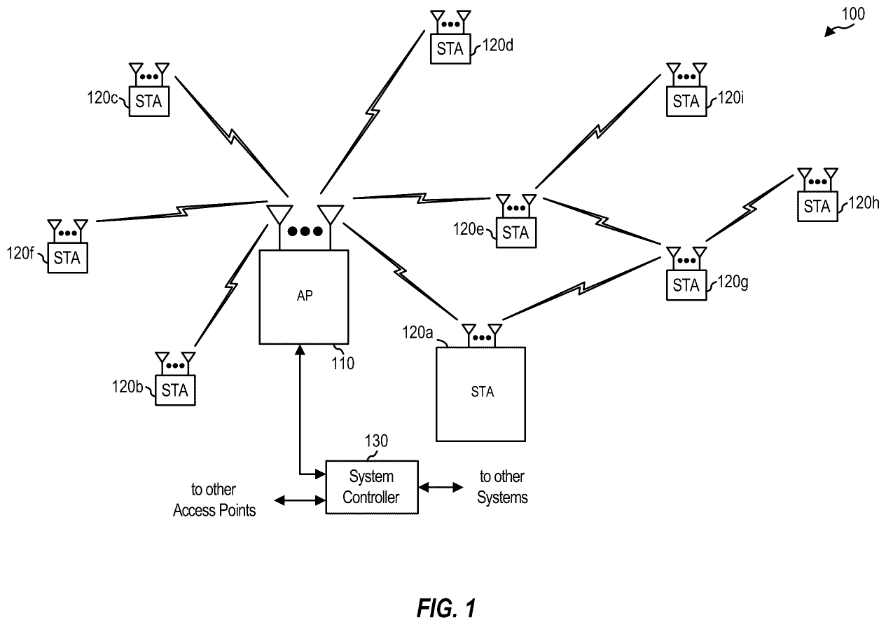

FIG. 1 is a diagram illustrating an example wireless communication system 100, in accordance with certain aspects of the present disclosure. System 100 may be a multiple-input multiple-output (MIMO)/multi-link operation (MLO) system 100. As shown in FIG. 1, an access point (AP) 110 includes an association manager 112 that may be configured to take one or more actions described herein. The wireless station (STA) 120a includes an association manager 122 that may be configured to take one or more actions described herein.

For simplicity, only one AP 110 is shown in FIG. 1. An AP is generally a fixed station that communicates with the wireless STAs and may also be referred to as a base station (B S) or some other terminology. A wireless STA may be fixed or mobile and may also be referred to as a mobile STA, a wireless device, or some other terminology. AP 110 may communicate with one or more wireless STAs 120 at any given moment on the downlink (DL) and/or uplink (UL). The DL (i.e., forward link) is the communication link from AP 110 to the wireless STAs 120, and the UL (i.e., reverse link) is the communication link from the wireless STAs 120 to AP 110. A wireless STA 120 may also communicate peer-to-peer with another wireless STA 120, for example, via a direct link such as a tunneled direct link setup (TDLS). A system controller 130 may be in communication with and provide coordination and control for the access points.

While portions of the following disclosure will describe wireless STAs 120 capable of communicating via Spatial Division Multiple Access (SDMA), for certain aspects, the wireless STAs 120 may also include some wireless STAs 120 that do not support SDMA. Thus, for such aspects, an AP 110 may be configured to communicate with both SDMA and non-SDMA wireless STAs 120. This approach may conveniently allow older versions of wireless STAs 120 (“legacy” stations) to remain deployed in an enterprise, extending their useful lifetime, while allowing newer SDMA wireless STAs 120 to be introduced as deemed appropriate.

System 100 employs multiple transmit and multiple receive antennas for data transmission on the DL and UL. AP 110 is equipped with Nₐₚ antennas and represents the multiple-input (MI) for DL transmissions and the multiple-output (MO) for UL transmissions. A set of K selected wireless stations 120 collectively represents the multiple-output for DL transmissions and the multiple-input for UL transmissions. For pure SDMA, it is desired to have Nₐₚ≥K≥1 if the data symbol streams for the K wireless STAs are not multiplexed in code, frequency or time by some means. K may be greater than Nₐₚ if the data symbol streams can be multiplexed using TDMA technique, different code channels with CDMA, disjoint sets of subbands with OFDM, and so on. Each selected wireless STA transmits user-specific data to and/or receives user-specific data from the access point. In general, each selected wireless STA may be equipped with one or multiple antennas (i.e., Nₛₜₐ≥1). The K selected wireless STAs can have the same or different number of antennas.

System 100 may be a time division duplex (TDD) system or a frequency division duplex (FDD) system. For a TDD system, the DL and UL share the same frequency band. For an FDD system, the DL and UL use different frequency bands. System 100 may also utilize a single carrier or multiple carriers for transmission. Each wireless STA may be equipped with a single antenna or multiple antennas. System 100 may also be a TDMA system if wireless STAs 120 share the same frequency channel by dividing transmission/reception into different time slots, each time slot being assigned to a different wireless STA 120. System 100 may also be a carrier sense multiple access (CSMA) with collision avoidance (CA) system, where STAs 120 perform carrier sensing to access the medium and attempt to avoid collisions by beginning transmission only after sending the channel to be idle.

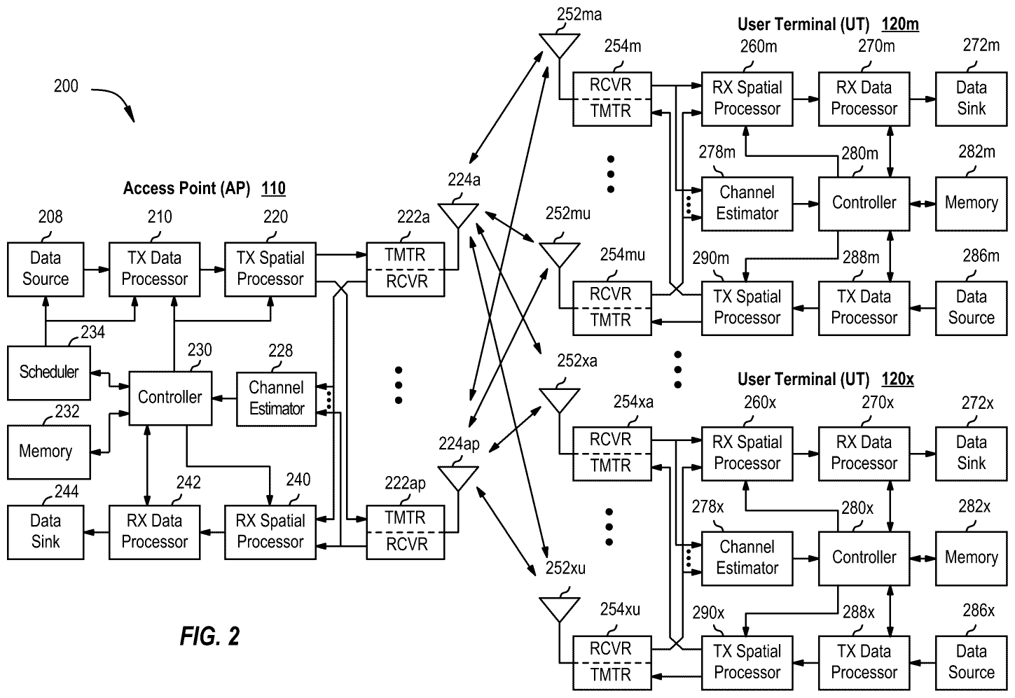

FIG. 2 illustrates a block diagram of AP 110 and two wireless STAs 120m and 120x in a MEVIO/MLO system, such as system 100, in accordance with certain aspects of the present disclosure.

AP 110 is equipped with Nₐₚ antennas 224a through 224t. Wireless STA 120m is equipped with N_{sta,m} antennas 252ma through 252mu, and wireless STA 120x is equipped with N_{sta,x} antennas 252xa through 252xu. AP 110 is a transmitting entity for the DL and a receiving entity for the UL. Each wireless STA 120 is a transmitting entity for the UL and a receiving entity for the DL. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “DL” denotes the downlink, the subscript “UL” denotes the uplink, N_{UL} wireless STAs are selected for simultaneous transmission on the uplink, N_{DL} wireless STAs are selected for simultaneous transmission on the downlink, N_{UL} may or may not be equal to N_{DL}, and N_{UL} and N_{DL} may be static values or can change for each scheduling interval. The beam-steering or some other spatial processing technique may be used at the access point and wireless station.

On the UL, at each wireless STA 120 selected for UL transmission, a transmit (TX) data processor 288 receives traffic data from a data source 286 and control data from a controller 280. TX data processor 288 processes (e.g., encodes, interleaves, and modulates) the traffic data for the wireless station based on the coding and modulation schemes associated with the rate selected for the wireless STA and provides a data symbol stream. A TX spatial processor 290 performs spatial processing on the data symbol stream and provides N_{sta,m} transmit symbol streams for the N_{sta,m} antennas. Each transceiver (TMTR) 254 receives and processes (e.g., converts to analog, amplifies, filters, and frequency upconverts) a respective transmit symbol stream to generate an uplink signal. N_{sta,m} transceivers 254 provide N_{sta,m} UL signals for transmission from N_{sta,m} antennas 252 to AP 110.

N_{UL} wireless STAs may be scheduled for simultaneous transmission on the uplink. Each of these wireless STAs performs spatial processing on its data symbol stream and transmits its set of transmit symbol streams on the UL to the AP 110.

At AP 110, Nₐₚ antennas 224a through 224ap receive the UL signals from all N_{UL} wireless STAs transmitting on the UL. Each antenna 224 provides a received signal to a respective transceiver (RCVR) 222. Each transceiver 222 performs processing complementary to that performed by transceiver 254 and provides a received symbol stream. A receive (RX) spatial processor 240 performs receiver spatial processing on the Nₐₚ received symbol streams from Nₐₚ transceiver 222 and provides N_{UL} recovered UL data symbol streams. The receiver spatial processing is performed in accordance with the channel correlation matrix inversion (CCMI), minimum mean square error (MMSE), soft interference cancellation (SIC), or some other technique. Each recovered UL data symbol stream is an estimate of a data symbol stream transmitted by a respective wireless station. An RX data processor 242 processes (e.g., demodulates, deinterleaves, and decodes) each recovered uplink data symbol stream in accordance with the rate used for that stream to obtain decoded data. The decoded data for each wireless STA may be provided to a data sink 244 for storage and/or a controller 230 for further processing.

On the DL, at AP 110, a TX data processor 210 receives traffic data from a data source 208 for N_{DL} wireless stations scheduled for downlink transmission, control data from a controller 230, and possibly other data from a scheduler 234. The various types of data may be sent on different transport channels. TX data processor 210 processes (e.g., encodes, interleaves, and modulates) the traffic data for each wireless station based on the rate selected for that wireless station. TX data processor 210 provides N_{DL} DL data symbol streams for the N_{DL} wireless stations. A TX spatial processor 220 performs spatial processing (such as a precoding or beamforming, as described in the present disclosure) on the N_{DL} DL data symbol streams, and provides Nₐₚ transmit symbol streams for the Nₐₚ antennas. Each transceiver 222 receives and processes a respective transmit symbol stream to generate a DL signal. Nₐₚ transceivers 222 providing Nₐₚ DL signals for transmission from Nₐₚ antennas 224 to the wireless STAs.

At each wireless STA 120, N_{sta,m} antennas 252 receive the Nₐₚ DL signals from access point 110. Each transceiver 254 processes a received signal from an associated antenna 252 and provides a received symbol stream. An RX spatial processor 260 performs receiver spatial processing on N_{sta,m} received symbol streams from N_{sta,m} transceiver 254 and provides a recovered DL data symbol stream for the wireless station. The receiver spatial processing is performed in accordance with the CCMI, MMSE or some other technique. An RX data processor 270 processes (e.g., demodulates, deinterleaves and decodes) the recovered DL data symbol stream to obtain decoded data for the wireless station.

At each wireless STA 120, a channel estimator 278 estimates the DL channel response and provides DL channel estimates, which may include channel gain estimates, SNR estimates, noise variance and so on. Similarly, a channel estimator 228 estimates the UL channel response and provides UL channel estimates. Controller 280 for each wireless STA typically derives the spatial filter matrix for the wireless station based on the downlink channel response matrix H_{dn,m} for that wireless station. Controller 230 derives the spatial filter matrix for the AP based on the effective UL channel response matrix H_{up,eff}. Controller 280 for each wireless STA may send feedback information (e.g., the downlink and/or uplink eigenvectors, eigenvalues, SNR estimates, and so on) to the AP. Controllers 230 and 280 also control the operation of various processing units at AP 110 and wireless STA 120, respectively.

While simultaneous uplink and downlink transmissions are described herein, it is understood that single downlink and uplink transmissions between devices may also be performed. Further, while AP scheduled transmissions are described, STAs may also send unscheduled transmissions. Further, while MIMO processing by the AP and STA are described, the system 100 may also support single antenna devices that do not use any spatial processing.

### Aspects Related to Calibrating RTT Errors

Aspects of the present disclosure provide mechanisms that may help increase ranging accuracy by recognizing the root cause of many RTT errors, estimating the RTT errors, and compensating for the RTT by adjusting receive timestamps.

Many RTT errors may be caused by using different filters and different RTT algorithms at the initiator and responder stations. Since it is generally difficult to mandate filter response and/or RTT algorithms in standard specifications (standards), aspects of the present disclosure propose mechanisms that may result in changes to standards to support reporting TX filter response for ranging frames, in order to facilitate the device who receives the ranging frame to estimate the RTT errors.

RTT devices are typically calibrated such that the RTT error is zero when both initiator and responder are similar devices (e.g., from the same vendor) and both devices use the same RTT algorithm and the same filtering. If devices are using different filtering and/or different RTT algorithms, this may result in an RTT error.

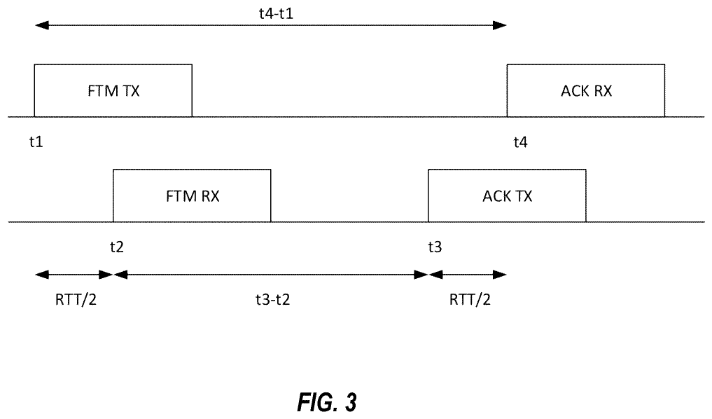

FIG. 3 depicts a timing diagram for an example RTT procedure. As illustrated, a first station (e.g., a responding station) sends a fine time measurement (FTM) frame and records the departure time (t1). This FTM frame is received at the second station (e.g., an initiating station), which records the reception time (t2). The second station may acknowledge receipt of the FTM frame by sending an acknowledgement (ACK) frame and recording the departure time (t3). The ACK frame is received at the first station, which records the reception time (t4).

The timestamps t1 and t4 may be reported back to the second (initiating) station, where the position is actually going to be computed. The timestamps t1 and t4 could be included in a subsequent FTM frame. Once the initiating station receives t1 and t4 from the responding station, the initiating station may compute its position as follows:

RTT=(t4−t1)−(t3−t2).

This RTT value can then be used to calculate distance as follows:

d=0.5·RTT·c,

where c is the propagation speed (i.e., the speed of light). Devices calibrate their reported T1..T4 times to make sure RTT is correct.

As noted above, performing RTT procedures with devices that use different Tx filtering may result in RTT errors, for example, depending on the RTT algorithms used. In some cases a threshold used to determine timestamps, such as a First Arrival Correction (FAC) threshold.

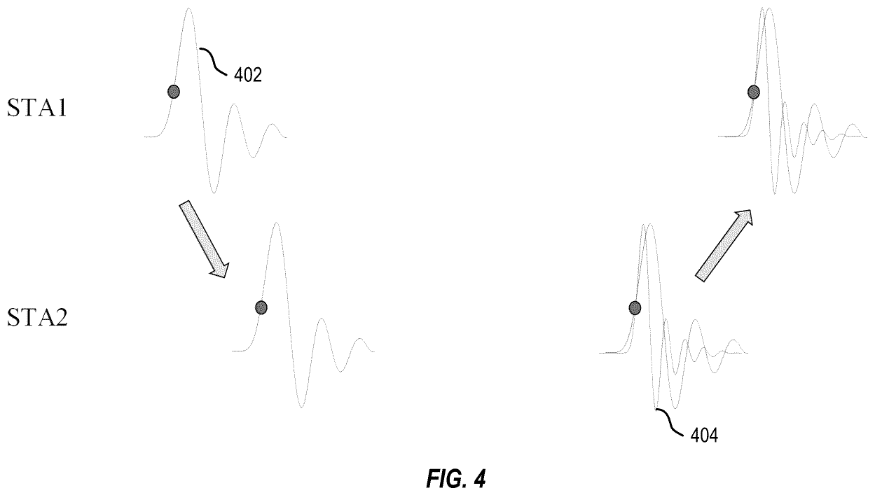

As illustrated in FIG. 4, devices that use different Tx filtering, but the same FAC threshold (as indicated by the dots) may not see a difference in RTT, even if they transmit different responses. In the illustrated example, STA1 and STA2 use different Tx filtering, resulting in a first transmit impulse response 402 from STA1 and second transmit impulse response 404 from STA2, but the same FAC threshold.

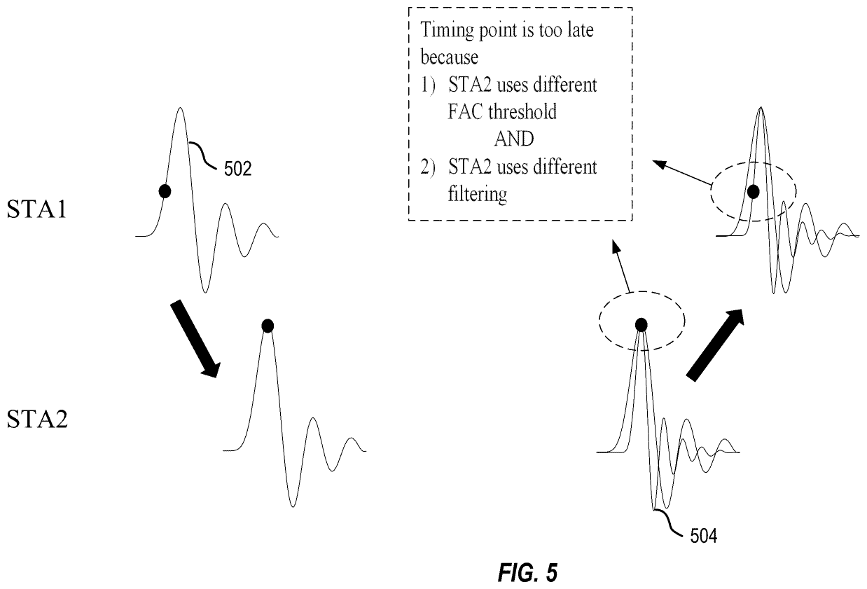

As illustrated in FIG. 5, devices that use different Tx filtering and different FAC thresholds (as indicated by the dots) may see a difference in RTT. In the illustrated example, STA1 and STA2 use different Tx filtering and different FAC thresholds, resulting in a first transmit impulse response 502 from STA1 and second transmit impulse response 504 from STA2. In this case, the timing point may be too late because: 1) STA2 may use a different FAC threshold; and STA2 may use different filtering.

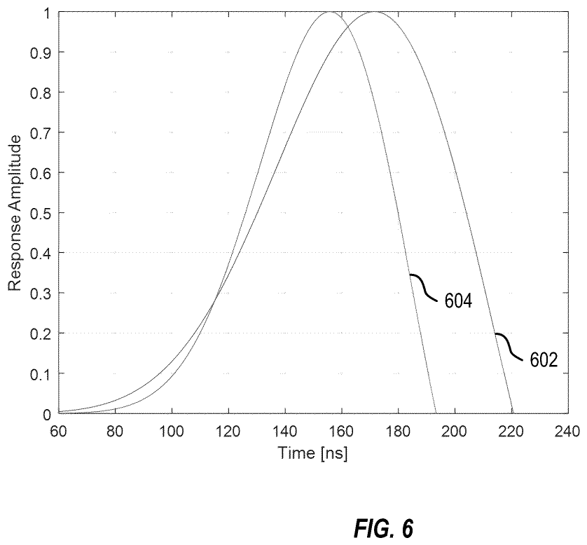

FIG. 6 depicts a graph 600 of an example of RTT error caused by filtering differences. In the figure, the different impulse responses are flat in 20 MHz within a dB but the first curve 602 has a more narrow Tx finite impulse response (TxFIR) than the second curve 604. If both STAs use same FAC threshold (e.g., of 0.3 in amplitude), then there is no timing error. If one STA uses an FAC threshold of 0.3 and the other uses an FAC threshold of 0.6, then there may be an error of 8 ns, which may result in an error in ranging accuracy of approximately 2.4 m.

If one STA uses a threshold of 0.3 and the other uses a threshold of 1 (e.g., no peak estimation), then may be an error of 16 ns (corresponding to 4.8 m). For higher bandwidth modes, errors are proportionally smaller. For 160 MHz, worst case error is 8× smaller (so about 0.6 m rather than 4.8 m). The example errors shown in FIG. 6 may be larger than the RTT noise error, which is <<1 m at high SNR in a cabled channel.

Other factors may contribute to RTT errors. For example, differences in filtering may also include different propagation delays. This could, for instance, be due to different ADC or DAC delays. In the present description, propagation delay is generally assumed to be included in the transmit and receive impulse responses, htx and hrx.

The impact of different propagation delays may be demonstrated by considering an example where STA1 and STA2 are identical, except that STA2 has an extra TX delay D2. If both STA1 and STA2 are calibrated using a clone of themselves, then there may be no RTT error. This is because STA2 adds D2 to both its T1 and T3 times (so T3−T2 is D2 larger) and STA1 sees an extra delay of D2 in T4 that is not there when STA2 would not have the extra TX delay. There is no RTT error in this case because the D2 term cancels when calculating RTT=(T4−T1)−(T3−T2).

A different result is obtained if STA1 is calibrated using STA2 that is calibrated using a clone of itself. The calibration adds D2 to T1 from STA1 (or subtracts D2 from T4), such that there is no RTT error between STA1 and STA2. There will be an RTT error of D2 when STA1 does a RTT to a clone of itself. This example illustrates the importance of using identical devices when doing RTT calibration, if there is no mechanism to estimate and compensate for the error.

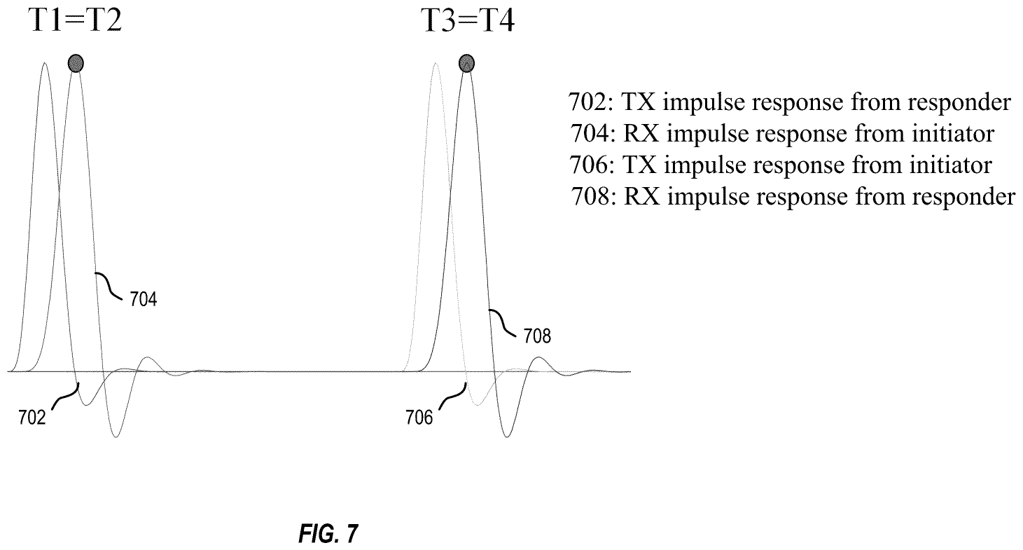

FIG. 7 illustrates an example of RTT calibration. The figure shows a TX impulse response 702 from the responder 702, an RX impulse response 704 from the initiator, a TX impulse response 706 from the initiator, and an RX impulse response 708 from the responder. Calibration may be performed in order to make sure that (T4−T1)−(T3−T2)=RTT. For example, assuming RTT=0 for simplicity, then T1 would need to be equal to T2 and T3 would need to be equal to T4. It may be allowable to have an equal bias in {T1,T4} and a different equal bias in {T2,T3} as such a bias cancels out in the RTT calculation. This bias could, for example, be the difference between the TX response time and the RX response time.

How RTT errors are caused by different filtering and RTT algorithms may be demonstrated by assuming an example where both STA1 and STA2 are perfectly calibrated to devices that are clones of STA1 and STA2. In this case, STA1 may be calibrated such that:
T1=T2=RTT1(conv(htx1,hrx1)); and
T4=T3=RTT1(conv(htx1,hrx1)).

Similarly, STA2 may be calibrated such that:
T1=T2=RTT2(conv(htx2,hrx2)); and
T4=T3=RTT2(conv(htx2,hrx2)),
   where RTT1( ) is the RTT algorithm of STA1 and RTT2( ) is the RTT algorithm of STA2. To have zero error when STA1 is used as responder and STA2 as initiator the T1,T2 and T4,T3 values must match except that T1,T4 may have a constant bias D relative to T2,T3:
T1=RTT1(conv(htx1,hrx1))=T2=RTT2(conv(htx1,hrx2))+D; and
T4=RTT1(conv(htx2,hrx1))=T3=RTT2(conv(htx2,hrx2))+D.
   It may be noted that the actual RTT is assumed to be zero in this example, since (T4−T1)−(T3−T2) reduces to 0 when T1=T2 and T4=T3, in order to focus entirely on the calibration errors.

The example above generally shows that RTT error involves 2 conditions:
RTT1(conv(htx1,hrx1))=RTT2(conv(htx1,hrx2))+D; and
RTT1(conv(htx2,hrx1))=RTT2(conv(htx2,hrx2))+D.
   This may be shown considering some examples. As a first example, if TX filtering is the same but RX filtering is different, then the 2 requirements reduce to 1:
RTT1(conv(htx1,hrx1))=RTT2(conv(htx1,hrx2))+D. This is true because RTT2( ) differs from RTT1( ) by some constant offset that depends on the difference in RX filtering. Hence there is no RTT error in this case. As a second example, RX filtering may be the same, but TX filtering is different, such that:
RTT1(conv(htx1,hrx1))=RTT2(conv(htx1,hrx1))+D; and
RTT1(conv(htx2,hrx1))=RTT2(conv(htx2,hrx1))+D.
   This may be true only if RTT1==RTT2, so both devices need to use the same RTT algorithm (e.g., same FAC thresholds for both devices). A third example assumes both TX and RX filtering are different. In this case, there is likely always some RTT error even if both devices use the same RTT algorithm.

RTT calibration could be performed using different devices. In this case, RTT devices may be calibrated such that RTT error is zero when both initiator and responder are similar devices, using the same RTT algorithm and the same filtering. If devices used for calibration have different filtering (including different propagation delays) and/or a different RTT algorithm, then that will cause RTT errors to other devices. One illustrative example assumes STA1 and STA2 with different TX and RX filters are calibrated such that:
T1=T2=RTT2(conv(htx1,hrx2)); and
T3=T4=RTT1(conv(htx2,hrx1)).
   To get a zero error when some third device is used as initiator which is calibrated using a clone of itself:
T1=RTT2(conv(htx1,hrx2))=T2=RTT3(conv(htx3,hrx3))+D; and
T4=RTT1(conv(htx2,hrx1))=T3=RTT3(conv(htx3,hrx3))+D
   ⇒RTT2(conv(htx1,hrx2))=RTT1(conv(htx2,hrx1)).
      This may be true for specific cases where the differences in filtering happens to be cancelled by the differences in RTT algorithm. In most cases there will be significant RTT errors. This again illustrates the importance of performing calibration with identical devices.

Due to the issues described above regarding RTT errors, using the current RTT method, a golden test device (e.g., a standardized testing device that can generally be used to calibrate any other device). For example, if STA1 happens to have same TX filtering as the test device, and STA2 has same RX filtering and same RTT algorithm as the test device, then the test device will show no RTT error to both STA1 and STA2, even though there can be a significant RTT error between STA1 and STA2.

In general, a test device will show some RTT error to STA1 and STA2 that depends on differences in TX/RX filtering and RTT algorithm that cannot be used to predict the RTT error between STA1 and STA2. With some extra measurements, however, it may be possible to make a golden test device. Such a test device may need to measure TX responses from 2 STAs in addition to RTT error. In this case, only oversampled peak samples may be enough. If both STAs know the TX response from the other STA, they can estimate an RTT calibration term that eliminates the RTT bias between them.

Aspects of the present disclosure may help resolving RTT bias by providing TX filtering to participating stations. For example, each STA may signal its oversampled TX impulse response peak htx. In some cases, only samples in some range of for instance +/−100 ns around the peak may be needed. In some cases, the initiator may estimate a difference T2d between T2 timing of conv(htx1,hrx2) versus conv(htx2,hrx2). The latter may be used by calibration for STA2. The responder may estimate a difference T4d between T4 timing of conv(htx2,hrx1) versus conv(htx1,hrx1). The latter is used by calibration for STA1.T2d and T4d may either be signaled in an FTM message, or they can be used to correct T2 and T4. This procedure may remove the RTT bias without having to know the RTT algorithm of each device. Each device may know its own RX filter response and RTT algorithm, hence it only needs to know the TX response from the other device to estimate the RTT error. This approach may assume that each device is perfectly calibrated using a clone of itself. If this condition does not hold, a test device could be used to resolve the residual RTT bias.

In some cases, a golden test device could be used to provide an accurate estimate of the overall TX impulse response of a device. This may ensure that all responses are estimated in the same way. Each device may signal its TX impulse response for each RTT measurement. It should be noted, however, that a device may have multiple TX responses depending on which mode is used (e.g., 20-in-20 and 20-in-160 modes may result in different TX responses). In some cases, a golden test device could be used to provide an estimate of the residual RTT error of a device after applying the TX response bias compensation. In some cases, residual RTT error can, for example, be caused by a device having some fixed bias in its T4−T1 or T3−T2 measurement.

Residual RTT error can be reported for each RTT measurement to compensate for this bias, or it could be used by a device to compensate its T4−T1 or T3−T2 measurements.

There may be a need for estimating overall TX impulse response, without impacting of any RX filtering nor effects of using an IFFT with rectangular windowing. To estimate the TX response, the frequency domain channel estimate, estimated by some reference receiver, can be divided by the known RX frequency response to cancel out the RX filtering. Impulse response h can be estimated from frequency domain channel H by doing the following:
h=Fs′*inv(Fs*Fs′)*H(subcarrier_ind); and
Fs=F(subcarrier_ind,time_ind),
   where F is N-point FFT matrix where N is large enough to get a high oversampling ratio in h. For example, N=1024 for 20 MHz mode gives 16× oversampling. Large oversampling may make it easier for a STA to do further interpolation to compute RTT correction term with resolution <<1 ns. Impulse response can also be estimated from:
subcarrier_ind: indices of subcarriers used in OFDM channel symbols; and
time_ind: indices in time domain including the peak, for example samples in range of 0..800 ns.
   Alternative methods may also exist to estimate h using MMSE or SVD.

Start time of impulse response typically does not matter for RTT bias as it drops out in T2d/T4d calculation. For example, if htx1 starts 50 ns earlier, then the corrected T2 is 50 ns smaller but T4 is 50 ns larger such that this 50 ns is cancelled when computing RTT=(T4−T1)−(T3−T2).

In the present description, it may be assumed that the calibration offset is independent of the fact whether a device is initiator or responder. This generally means that a device applies the same offset to T1 and T3 (TX offset) and to T2 and T4 (RX offset). If this were not the case, there may be additional RTT errors.

In one example, it may be assumed that STA1 and STA2 are identical except for an additional receiver delay D in STA2. If STA2 applies CAL offset of D on both T1 and T3, then there is no RTT error to STA1 nor to any other STA with a different receiver delay. If STA2 is the initiator, then T4−T1 from STA1 is D larger because of extra delay and T3−T2 is D larger because of STA2 CAL, hence no RTT error.

If STA2 applies a CAL offset of 2D to T1 but nothing to T3, then there is an RTT error to other STAs that have a receiver delay different from D. If STA2 is initiator, then T4−T1 from STA1 is D larger because of extra delay but T3−T2 is not changed: there is an RTT error=D. If STA2 is the responder, then T4−T1 from STA2 is D-2D smaller, T3−T2 is not changed: and there is a RTT error=−D. If STA2 does RTT to a clone of itself, then T4−T1 is D-2D smaller, T3−T2 is D larger: in this case RTT error=0.

As described herein, differences in filtering and RTT algorithms cause an RTT bias between different devices. Eliminating RTT error between different devices may require knowledge of TX impulse response of the other device. In some cases, calculation of a correction term may be based on differences in TX responses by both initiator and responder. Alternatively these corrections could both be calculated at one device, but that requires that device to know the RTT algorithms used by the different devices in addition to the TX responses of both devices. RTT calibration should be done using identical devices.

As noted above, a golden test device may not exist except if the above TX response correction is done. A golden test device would be a good way to get the TX response from a device under test plus any residual RTT error.

Implementing the techniques described herein may involve a potential change in standard to solve the bias issue. For example, changes may need to accommodate sending a TX response plus residual RTT error from a test device in an FTM message or in capability field.

In some cases, the information may be signaled in each FTM message as the TX response and RTT algorithm may change depending on packet bandwidth SNR and potentially other factors.

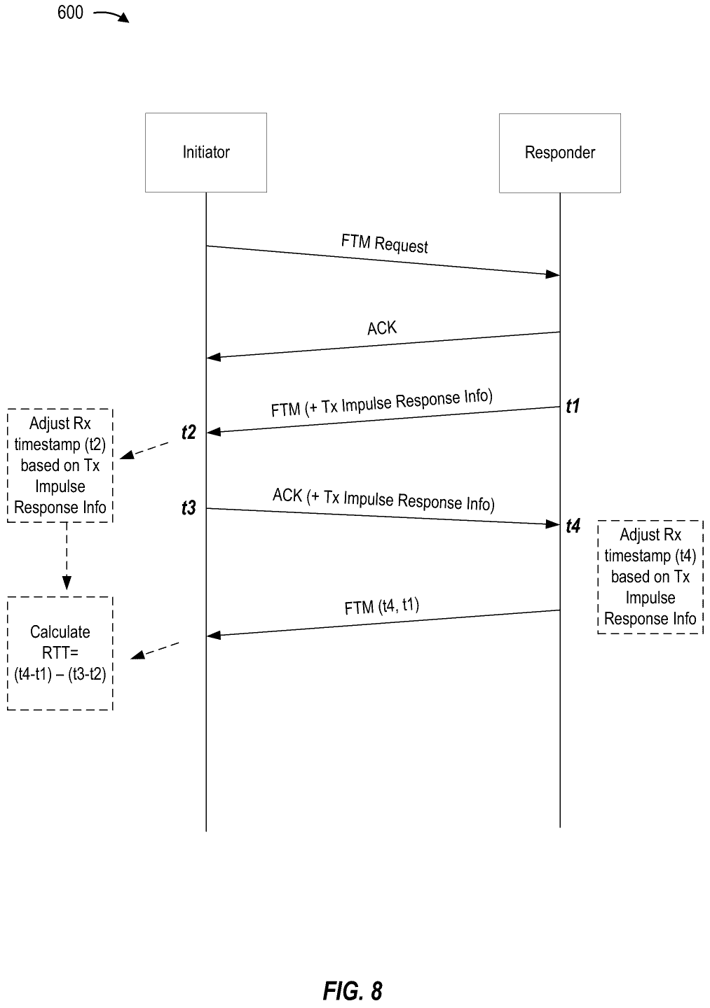

The enhancements to the ranging procedure proposed herein may be understood with reference to the call flow diagram 800 of FIG. 8.

As illustrated, a responder may transmit an FTM frame, for the initiator to measure a timestamp from. For each such ranging frame that is used to estimate timestamps, the transmitter of the ranging frame may signal information regarding the TX impulse response of the ranging frame. Based on the information, the initiator may adjust its Rx timestamp (t2).

Similarly, the initiator may transmit an ACK frame, for the responder to measure a timestamp from. For each such ranging frame that is used to estimate timestamps, the initiator may signal information regarding the TX impulse response of the ranging frame. Based on the information, the responder may adjust its Rx timestamp (t4). As illustrated, the responder may provide an indication of t4 and t1 to the initiator. The initiator may use the values of t4 and t1, received from the responder, along with t2 and t3 that were recorded at the initiator, for use in calculating RTT.

In some cases, the content of Tx IR information can be a number of samples around the peak of the impulse response. The sampling rate can be prescribed or signaled as part of the ranging procedure. Samples are preferably complex in-phase and quadrature samples. An alternative Tx IR information would be to use the sampled frequency response.

The signaling can be done in an “immediate” fashion for the current ranging frame, or in a “delayed” fashion for the previous ranging frame. For example, as illustrated in FIG. 8, the signaling can be included in the ranging frame itself (e.g., if the ranging frame is an FTM frame or an ACK frame which has data payload), or included in the LMR (Location Measurement Report) frame (e.g., if the ranging frame is a Ranging NDP frame which has no data payload).

It is generally relatively difficult to change the ACK frame content, so another option is for the transmitter of the ACK frame to send another frame. For example, the other frame could be transmitted at the end of the sounding sequence to report the TX impulse response of the ACK frame for each of the ACK frames sent in the sounding sequence along with token information. This also means that, the receiver of the ACK frame may not have the knowledge of the TX impulse response of the ACK frame until the end of the sounding sequence and, thus, cannot correct the errors in the RX timestamp of the ACK frame until at the end of the sounding sequence. Therefore, the receiver of the ACK frame needs to send another frame to report the residual error in the RX timestamp of the ACK frame for each of the ACK frames received in the sounding sequence.

The residual error in the RX timestamp of each ranging frame can also be reported to facilitate a test device to report the calibration result. The report can be done in the ranging frame itself, in the LMR frame, or in a separate frame

### Example Operations of a First Wireless Node

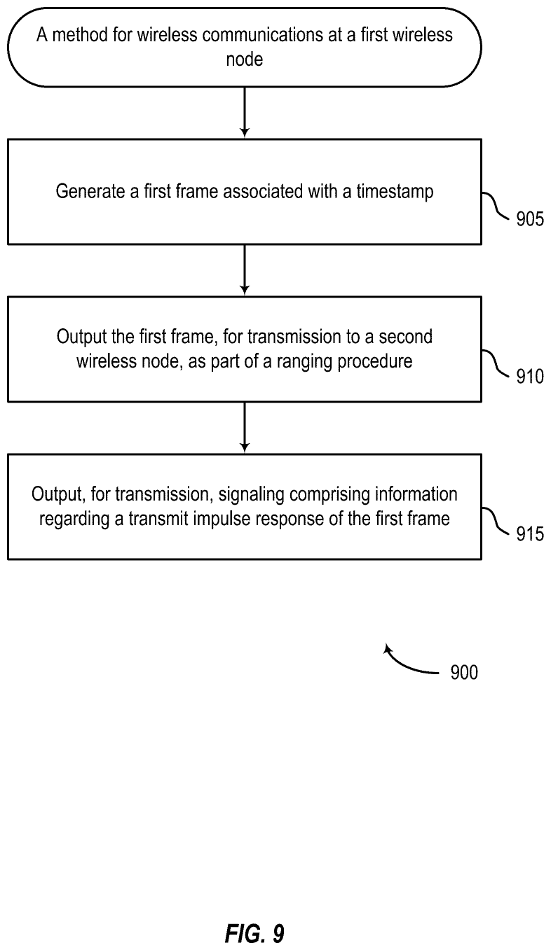

FIG. 9 shows an example of a method 900 for wireless communications at a first wireless node. In some examples, the first wireless node is a station, such as a STA 120 of FIGS. 1 and 2. In some examples, the first wireless node is an AP device, such as an AP 110 of FIGS. 1 and 2.

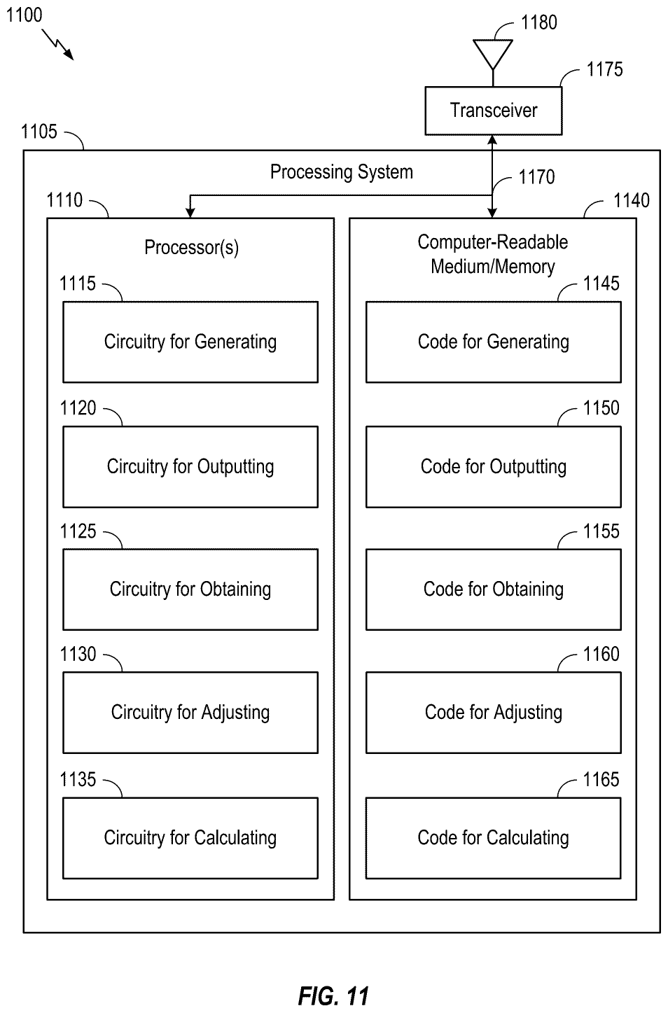

Method 900 begins at step 905 with generating a first frame associated with a timestamp. In some cases, the operations of this step refer to, or may be performed by, circuitry for generating and/or code for generating as described with reference to FIG. 11.

Method 900 then proceeds to step 910 with outputting the first frame, for transmission to a second wireless node, as part of a ranging procedure. In some cases, the operations of this step refer to, or may be performed by, circuitry for outputting and/or code for outputting as described with reference to FIG. 11.

Method 900 then proceeds to step 915 with outputting, for transmission, signaling comprising information regarding a transmit impulse response of the first frame. In some cases, the operations of this step refer to, or may be performed by, circuitry for outputting and/or code for outputting as described with reference to FIG. 11.

In some aspects, the information is signaled via the first frame.

In some aspects, the first frame comprises: a FTM frame; an ACK frame; or a LMR frame.

In some aspects, outputting, for transmission, signaling comprising information regarding the transmit impulse response of the first frame comprises: outputting the information for transmission via a second frame after outputting the first frame for transmission.

In some aspects, the first frame comprises an acknowledgment frame output for transmission as part of a sounding sequence; and the second frame is output for transmission after the sounding sequence.

In some aspects, the second frame includes information regarding transmit impulse responses of multiple acknowledgment frames that are part of the sounding sequence.

In some aspects, the method 900 further includes obtaining, as part of the ranging procedure, signaling indicating a receive timestamp for each of the acknowledgment frames, as received at the second wireless node. In some cases, the operations of this step refer to, or may be performed by, circuitry for obtaining and/or code for obtaining as described with reference to FIG. 11.

In some aspects, the method 900 further includes obtaining, after the sounding sequence, an indication of a residual error in each of the receive timestamps. In some cases, the operations of this step refer to, or may be performed by, circuitry for obtaining and/or code for obtaining as described with reference to FIG. 11.

In some aspects, the method 900 further includes adjusting the receive timestamps, based on the indication of the residual error. In some cases, the operations of this step refer to, or may be performed by, circuitry for adjusting and/or code for adjusting as described with reference to FIG. 11.

In some aspects, the method 900 further includes calculating a RTT, based on the adjusted receive timestamps, as part of the ranging procedure. In some cases, the operations of this step refer to, or may be performed by, circuitry for calculating and/or code for calculating as described with reference to FIG. 11.

In some aspects, the method 900 further includes outputting a frame with a value determined based on the calculated RTT. In some cases, the operations of this step refer to, or may be performed by, circuitry for outputting and/or code for outputting as described with reference to FIG. 11.

In some aspects, the method 900 further includes obtaining, from the second wireless node, a second frame associated with a timestamp. In some cases, the operations of this step refer to, or may be performed by, circuitry for obtaining and/or code for obtaining as described with reference to FIG. 11.

In some aspects, the method 900 further includes obtaining information regarding a transmit impulse response of the second frame. In some cases, the operations of this step refer to, or may be performed by, circuitry for obtaining and/or code for obtaining as described with reference to FIG. 11.

In some aspects, the method 900 further includes adjusting an estimated receive timestamp for the second frame, based on the information regarding the transmit impulse response of the second frame. In some cases, the operations of this step refer to, or may be performed by, circuitry for adjusting and/or code for adjusting as described with reference to FIG. 11.

In some aspects, the method 900 further includes outputting for transmission signaling of third information regarding residual error in the estimated receive timestamp. In some cases, the operations of this step refer to, or may be performed by, circuitry for outputting and/or code for outputting as described with reference to FIG. 11.

In some aspects, the information regarding the residual error in the estimated receive timestamp is signaled via: the first frame; or a LMR frame.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Second Wireless Node

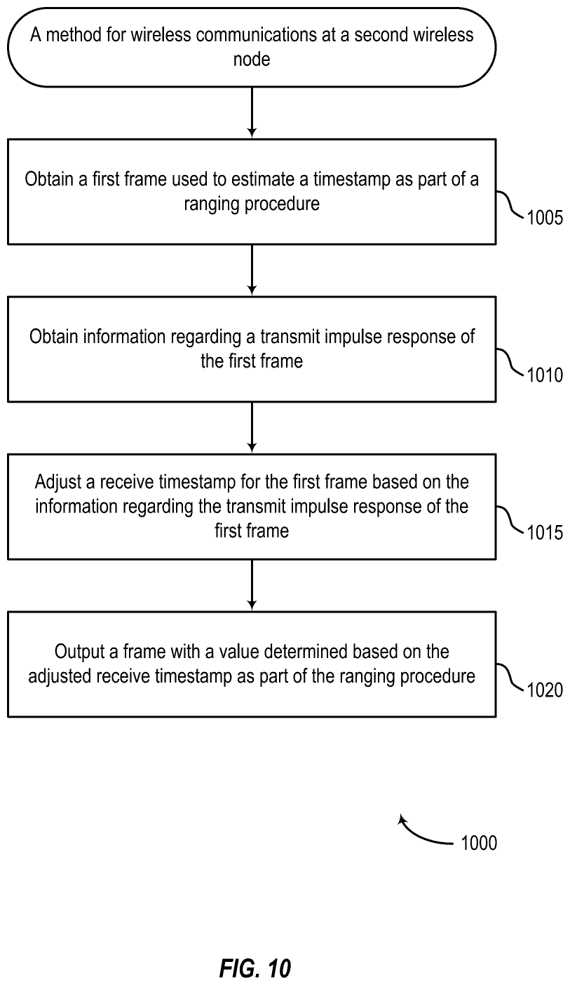

FIG. 10 shows an example of a method 1000 for wireless communications at a second wireless node. In some examples, the second wireless node is a station, such as a STA 120 of FIGS. 1 and 2. In some examples, the second wireless node is an AP device, such as an AP 110 of FIGS. 1 and 2.

Method 1000 begins at step 1005 with obtaining a first frame used to estimate a timestamp as part of a ranging procedure. In some cases, the operations of this step refer to, or may be performed by, circuitry for obtaining and/or code for obtaining as described with reference to FIG. 11.

Method 1000 then proceeds to step 1010 with obtaining information regarding a transmit impulse response of the first frame. In some cases, the operations of this step refer to, or may be performed by, circuitry for obtaining and/or code for obtaining as described with reference to FIG. 11.

Method 1000 then proceeds to step 1015 with adjusting a receive timestamp for the first frame based on the information regarding the transmit impulse response of the first frame. In some cases, the operations of this step refer to, or may be performed by, circuitry for adjusting and/or code for adjusting as described with reference to FIG. 11.

Method 1000 then proceeds to step 1020 with outputting a frame with a value determined based on the adjusted receive timestamp as part of the ranging procedure. In some cases, the operations of this step refer to, or may be performed by, circuitry for outputting and/or code for outputting as described with reference to FIG. 11.

In some aspects, the information is obtained via the first frame.

In some aspects, the first frame comprises: a FTM frame; an ACK frame; or a LMR frame.

In some aspects, obtaining information regarding a transmit impulse response of the first frame comprises: obtaining the information via a second frame after obtaining the first frame.

In some aspects, the first frame comprises an acknowledgment frame obtained as part of a sounding sequence; and the second frame is obtained after the sounding sequence.

In some aspects, the second frame includes information regarding transmit impulse responses of multiple acknowledgment frames that are part of the sounding sequence.

In some aspects, the method 1000 further includes outputting for transmission, as part of the ranging procedure, signaling indicating a receive timestamp for each of the acknowledgment frames, as received at the second wireless node. In some cases, the operations of this step refer to, or may be performed by, circuitry for outputting and/or code for outputting as described with reference to FIG. 11.

In some aspects, the method 1000 further includes outputting, after the sounding sequence, an indication of a residual error in each of the receive timestamps. In some cases, the operations of this step refer to, or may be performed by, circuitry for outputting and/or code for outputting as described with reference to FIG. 11.

In some aspects, the method 1000 further includes outputting for transmission a second frame used to estimate a timestamp as part of the ranging procedure. In some cases, the operations of this step refer to, or may be performed by, circuitry for outputting and/or code for outputting as described with reference to FIG. 11.

In some aspects, the method 1000 further includes outputting information regarding a transmit impulse response of the second frame. In some cases, the operations of this step refer to, or may be performed by, circuitry for outputting and/or code for outputting as described with reference to FIG. 11.

In some aspects, the method 1000 further includes outputting for transmission signaling of information regarding residual error in the receive timestamp. In some cases, the operations of this step refer to, or may be performed by, circuitry for outputting and/or code for outputting as described with reference to FIG. 11.

In some aspects, outputting for transmission signaling of information regarding the residual error in the receive timestamp comprises outputting the information regarding the residual error in the receive timestamp via: a second frame used to estimate a timestamp as part of a ranging procedure; or a LMR frame.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device

FIG. 11 depicts aspects of an example communications device 1100. In some aspects, communications device 1100 is a station, such as a STA 120 described above with respect to FIGS. 1 and 2. In some aspects, communications device 1100 is an AP, such as an AP 110 described above with respect to FIGS. 1 and 2.

The communications device 1100 includes a processing system 1105 coupled to the transceiver 1175 (e.g., a transmitter and/or a receiver). The transceiver 1175 is configured to transmit and receive signals for the communications device 1100 via the antenna 1180, such as the various signals as described herein. The transceiver 1175 may be an example of aspects of transceiver 222 and/or transceiver 254 described with reference to FIG. 2. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of the RX data processor 270, the TX data processor 288, the TX spatial processor 290, or the controller 280 of STA 120 illustrated in FIG. 2. In various aspects, the one or more processors 1110 may be representative of one or more of the RX data processor 242, the TX data processor 210, the TX spatial processor 220, or the controller 230 of AP 110 illustrated in FIG. 2. The one or more processors 1110 are coupled to a computer-readable medium/memory 1140 via a bus 1170. In certain aspects, the computer-readable medium/memory 1140 is configured to store instructions (e.g., computer-executable code) that when executed by the one or more processors 1110, cause the one or more processors 1110 to perform: the method 900 described with respect to FIG. 9, or any aspect related to it; and/or the method 1000 described with respect to FIG. 10, or any aspect related to it. Note that reference to a processor performing a function of communications device 1100 may include one or more processors 1110 performing that function of communications device 1100.

In the depicted example, computer-readable medium/memory 1140 stores code (e.g., executable instructions), such as code for generating 1145, code for outputting 1150, code for obtaining 1155, code for adjusting 1160, and code for calculating 1165. Processing of the code for generating 1145, code for outputting 1150, code for obtaining 1155, code for adjusting 1160, and code for calculating 1165 may cause the communications device 1100 to perform: the method 900 described with respect to FIG. 9, or any aspect related to it; and/or the method 1000 described with respect to FIG. 10, or any aspect related to it.

The one or more processors 1110 include circuitry configured to implement (e.g., execute) the code stored in the computer-readable medium/memory 1140, including circuitry such as circuitry for generating 1115, circuitry for outputting 1120, circuitry for obtaining 1125, circuitry for adjusting 1130, and circuitry for calculating 1135. Processing with circuitry for generating 1115, circuitry for outputting 1120, circuitry for obtaining 1125, circuitry for adjusting 1130, and circuitry for calculating 1135 may cause the communications device 1100 to perform: the method 900 described with respect to FIG. 9, or any aspect related to it; and/or the method 1000 described with respect to FIG. 10, or any aspect related to it.

Various components of the communications device 1100 may provide means for performing: the method 900 described with respect to FIG. 9, or any aspect related to it; and/or the method 1000 described with respect to FIG. 10, or any aspect related to it. For example, in some cases, means for transmitting, sending or outputting for transmission may include the transmitter unit 254 or antenna(s) 252 of the STA 120 illustrated in FIG. 2 and/or the transceiver 1175 and the antenna 1180 of the communications device 1100 in FIG. 11. In some cases, means for transmitting, sending or outputting for transmission may include the transmitter unit 222 or an antenna(s) 224 of AP 110 illustrated in FIG. 2 and/or the transceiver 1175 and the antenna 1180 of the communications device 1100 in FIG. 11. In some aspects, means for receiving or obtaining may include the receiver unit 254 or antenna(s) 252 of STA 120 illustrated in FIG. 2 and/or the transceiver 1175 and the antenna 1180 of the communications device 1100 in FIG. 11. In some aspects, means for receiving or obtaining may include the receiver unit 222 or an antenna(s) 224 of AP 110 illustrated in FIG. 2 and/or the transceiver 1175 and the antenna 1180 of the communications device 1100 in FIG. 11. In some aspects, means for generating, means for calculating, means for adjusting, and/or means for estimating may include one or more of the processors illustrated in FIG. 2.

### Example Clauses

Implementation examples are described in the following numbered clauses:

Clause 1: A method for wireless communications at a first wireless node, comprising: generating a first frame associated with a timestamp; outputting the first frame, for transmission to a second wireless node, as part of a ranging procedure; and outputting, for transmission, signaling comprising information regarding a transmit impulse response of the first frame.

Clause 2: The method of Clause 1, wherein the information is signaled via the first frame.

Clause 3: The method of Clause 2, wherein the first frame comprises: a FTM frame; an ACK frame; or a LMR frame.

Clause 4: The method of any one of Clauses 1-3, wherein outputting, for transmission, signaling comprising information regarding the transmit impulse response of the first frame comprises: outputting the information for transmission via a second frame after outputting the first frame for transmission.

Clause 5: The method of Clause 4, wherein: the first frame comprises an acknowledgment frame output for transmission as part of a sounding sequence; and the second frame is output for transmission after the sounding sequence.

Clause 6: The method of Clause 5, wherein the second frame includes information regarding transmit impulse responses of multiple acknowledgment frames that are part of the sounding sequence.

Clause 7: The method of Clause 6, further comprising: obtaining, as part of the ranging procedure, signaling indicating a receive timestamp for each of the acknowledgment frames, as received at the second wireless node, obtaining, after the sounding sequence, an indication of a residual error in each of the receive timestamps, adjusting the receive timestamps, based on the indication of the residual error, calculating a RTT, based on the adjusted receive timestamps, as part of the ranging procedure, and outputting a frame with a value determined based on the calculated RTT.

Clause 8: The method of any one of Clauses 1-7, further comprising: obtaining, from the second wireless node, a second frame associated with a timestamp, obtaining information regarding a transmit impulse response of the second frame, and adjusting an estimated receive timestamp for the second frame, based on the information regarding the transmit impulse response of the second frame.

Clause 9: The method of Clause 8, further comprising: outputting for transmission signaling of third information regarding residual error in the estimated receive timestamp.

Clause 10: The method of Clause 9, wherein the information regarding the residual error in the estimated receive timestamp is signaled via: the first frame; or a LMR frame.

Clause 11: A method for wireless communications at a second wireless node, comprising: obtaining a first frame used to estimate a timestamp as part of a ranging procedure; obtaining information regarding a transmit impulse response of the first frame; adjusting a receive timestamp for the first frame based on the information regarding the transmit impulse response of the first frame; and outputting a frame with a value determined based on the adjusted receive timestamp as part of the ranging procedure.

Clause 12: The method of Clause 11, wherein the information is obtained via the first frame.

Clause 13: The method of Clause 12, wherein the first frame comprises: a FTM frame; an ACK frame; or a LMR frame.

Clause 14: The method of any one of Clauses 11-13, wherein obtaining information regarding a transmit impulse response of the first frame comprises: obtaining the information via a second frame after obtaining the first frame.

Clause 15: The method of Clause 14, wherein: the first frame comprises an acknowledgment frame obtained as part of a sounding sequence; and the second frame is obtained after the sounding sequence.

Clause 16: The method of Clause 15, wherein the second frame includes information regarding transmit impulse responses of multiple acknowledgment frames that are part of the sounding sequence.

Clause 17: The method of Clause 16, further comprising: outputting for transmission, as part of the ranging procedure, signaling indicating a receive timestamp for each of the acknowledgment frames, as received at the second wireless node and outputting, after the sounding sequence, an indication of a residual error in each of the receive timestamps.

Clause 18: The method of any one of Clauses 11-17, further comprising: outputting for transmission a second frame used to estimate a timestamp as part of the ranging procedure and outputting information regarding a transmit impulse response of the second frame.

Clause 19: The method of any one of Clauses 11-18, further comprising: outputting for transmission signaling of information regarding residual error in the receive timestamp.

Clause 20: The method of Clause 19, wherein outputting for transmission signaling of information regarding the residual error in the receive timestamp comprises outputting the information regarding the residual error in the receive timestamp via: a second frame used to estimate a timestamp as part of a ranging procedure; or a LMR frame.

Clause 21: An apparatus, comprising: a memory comprising executable instructions; and a processor configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by a processor of an apparatus, cause the apparatus to perform a method in accordance with any one of Clauses 1-20.

Clause 24: A computer program product embodied on a computer-readable storage medium comprising code for performing a method in accordance with any one of Clauses 1-20.

Clause 25: A wireless node, comprising: at least one transceiver; a memory comprising instructions; and one or more processors configured to execute the instructions and cause the wireless node to perform a method in accordance with any one of Clauses 1-10, wherein the at least one transceiver is configured to transmit the first frame.

Clause 26: A wireless node, comprising: at least one transceiver; a memory comprising instructions; and one or more processors configured to execute the instructions and cause the wireless node to perform a method in accordance with any one of Clauses 11-20, wherein the at least one transceiver is configured to receive the first frame.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus comprising: a memory comprising processor-executable instructions; and one or more processors configured to execute the processor-executable instructions and cause the apparatus to:
generate a first frame associated with a timestamp;
output the first frame, for transmission to a wireless node, as part of a ranging procedure; and
output, for transmission, signaling comprising information regarding a transmit impulse response of the first frame.

2. The apparatus of claim 1, wherein the information is signaled via the first frame.

3. The apparatus of claim 2, wherein the first frame comprises:
a fine time measurement (FTM) frame;
an acknowledgment (ACK) frame; or
a location measurement report (LMR) frame.

4. The apparatus of claim 1, wherein outputting, for transmission, signaling comprising information regarding the transmit impulse response of the first frame comprises:
outputting the information for transmission via a second frame after outputting the first frame for transmission.

5. The apparatus of claim 4, wherein:
the first frame comprises an acknowledgment frame output for transmission as part of a sounding sequence; and
the second frame is output for transmission after the sounding sequence.

6. The apparatus of claim 5, wherein the second frame includes information regarding transmit impulse responses of multiple acknowledgment frames that are part of the sounding sequence.

7. The apparatus of claim 6, wherein the one or more processors are configured to execute the processor-executable instructions and cause the apparatus to:
obtain, as part of the ranging procedure, signaling indicating a receive timestamp for each of the acknowledgment frames, as received at the wireless node;
obtain, after the sounding sequence, an indication of a residual error in each of the receive timestamps;
adjust the receive timestamps, based on the indication of the residual error; and
calculate a round trip time (RTT), based on the adjusted receive timestamps, as part of the ranging procedure; and
output a frame with a value determined based on the calculated RTT.

8. The apparatus of claim 1, wherein the one or more processors are configured to execute the processor-executable instructions and cause the apparatus to:
obtain, from the wireless node, a second frame;
estimate a receive timestamp based on the second frame;
obtain information regarding a transmit impulse response of the second frame; and
adjust the estimated receive timestamp, based on the information regarding the transmit impulse response of the second frame.

9. The apparatus of claim 8, wherein the one or more processors are configured to execute the processor-executable instructions and cause the apparatus to output for transmission signaling of third information regarding a residual error in the estimated receive timestamp.

10. The apparatus of claim 9, wherein the information regarding the residual error in the estimated receive timestamp is signaled via:
the first frame; or
a location measurement report (LMR) frame.

11. An apparatus comprising: a memory comprising processor-executable instructions; and one or more processors configured to execute the processor-executable instructions and cause the apparatus to:
obtain, from a wireless node, a first frame as part of a ranging procedure;
estimate a timestamp based on the first frame;
obtain information regarding a transmit impulse response of the first frame;
adjust the estimated timestamp for the first frame based on the information regarding the transmit impulse response of the first frame; and
output a frame with a value determined based on the adjusted estimated timestamp as part of the ranging procedure.

12. The apparatus of claim 11, wherein the information is obtained via the first frame.

13. The apparatus of claim 12, wherein the first frame comprises:
a fine time measurement (FTM) frame;
an acknowledgment (ACK) frame; or
a location measurement report (LMR) frame.

14. The apparatus of claim 11, wherein:
obtaining information regarding a transmit impulse response of the first frame comprises obtaining the information via a second frame after obtaining the first frame;
the first frame comprises an acknowledgment frame obtained as part of a sounding sequence; and
the second frame is obtained after the sounding sequence.

15. The apparatus of claim 14, wherein the second frame includes information regarding transmit impulse responses of multiple acknowledgment frames that are part of the sounding sequence.

16. The apparatus of claim 15, wherein the one or more processors are configured to execute the processor-executable instructions and cause the apparatus to:
output for transmission, as part of the ranging procedure, signaling indicating a receive timestamp for each of the acknowledgment frames, as received at the apparatus; and
output, after the sounding sequence, an indication of a residual error in each of the receive timestamps.

17. The apparatus of claim 11, wherein the one or more processors are configured to execute the processor-executable instructions and cause the apparatus to:
output for transmission a second frame used to estimate a timestamp as part of the ranging procedure; and
output information regarding a transmit impulse response of the second frame.

18. The apparatus of claim 11, wherein the one or more processors are configured to execute the processor-executable instructions and cause the apparatus to output for transmission signaling of information regarding residual error in the estimated timestamp via:
a second frame used to estimate a timestamp as part of a ranging procedure; or
a location measurement report (LMR) frame.

19. The apparatus of claim 11, further comprising at least one transceiver, wherein the at least one transceiver is configured to receive the first frame and the apparatus is configured to operate as a wireless station.

20. A wireless node comprising: at least one transceiver, a memory comprising processor-executable instructions; and one or more processors configured to execute the processor-executable instructions and cause the wireless node to:
generate a first frame associated with a timestamp;
transmit, via the at least one transceiver, the first frame to another wireless node, as part of a ranging procedure; and
transmit, via the at least one transceiver, signaling comprising information regarding a transmit impulse response of the first frame.
